(19) United States
(12) Patent Application Publication
(10) Pub. No.: US 2024/0416698 A1
(43) Pub. Date: Dec. 19, 2024

(54) WIRING CONNECTOR WITH IMPROVED MECHANISMS FOR COUPLING WITH TOWING VEHICLE AND TOWED VEHICLE WIRING

(71) Applicant: HOPKINS MANUFACTURING CORPORATION, Cleveland, OH (US)

(72) Inventors: Vicki Sickler, Cleveland, OH (US); Robert N. Watts, Cleveland, OH (US)

(73) Assignee: HOPKINS MANUFACTURING CORPORATION, Cleveland, OH (US)

(21) Appl. No.: 18/743,711

(22) Filed: Jun. 14, 2024

Related U.S. Application Data
(60) Provisional application No. 63/508,026, filed on Jun. 14, 2023.

(51) Int. Cl. B60D 1/64; H01R 13/502

(52) U.S. Cl. CPC B60D 1/64; H01R 13/502; H01R 2201/26

(57) ABSTRACT

A wiring connector assembly that connects a towed vehicle to a towing vehicle. The wiring connector assembly connects and secures conventional wiring to transfer power to a towed vehicle without the need for additional tools or small screws. The wiring connector assembly includes a vehicle side connector and a trailer side sub-assembly. A center wire is connected by inserting and screwing into the trailer side sub-assembly. Additional wires are inserted into a spring while a lever is in an open position, once connected the lever can be moved to a closed position to secure the wire with the spring.

### CLAIM OF PRIORITY TO PRIOR APPLICATION

This application claims the benefit of the filing date of U.S. Provisional application, Ser. No. 63/508,026 filed on Jun. 14, 2023, entitled “Wiring Connector with Improved Mechanism for Coupling with Towing Vehicle and Towed Vehicle Wiring”. By this reference the entire disclosure, including the claims and drawings, of U.S. Provisional application, Ser. No. 63/508,026 is hereby incorporated into the present disclosure as though now set forth in its entirety.

### BACKGROUND OF THE INVENTION

### 1. Field of the Invention

The present invention relates generally to wiring connector for a trailer, and, specifically to a wiring connector for a trailer with an improved mechanism for coupling.

### 2. Description of Related Art

Wiring connectors or adaptors connect some of the electrical wiring of a towing vehicle such as a truck to the electrical wiring of a towed vehicle such as an RV, boat, or trailer so that the brakes, lights, and/or turn signals of the towed vehicle are synchronized with the towing vehicle. Such connectors/adaptors comprise a vehicle side connector that connects to some of the wiring of a towing vehicle and a trailer side connector that connects to the wires of a towed vehicle. Before these connectors/adaptors can be coupled together, they must be connected to the wires of the towing and towed vehicle. Often such connectors or adaptors require a screwdriver and small screws that can be difficult to install for a user and are easily lost.

### BRIEF SUMMARY OF THE INVENTION

Disclosed embodiments provide for an improved device that can easily connect wires from a towing vehicle to a towed vehicle without needing small fasteners to secure the wiring.

The present invention connects and secures conventional wiring to transfer power to a towed vehicle from a towing vehicle for lighting, auxiliary power, and brake systems. Assemblies can provide for wire retention for 18 thru 10-gauge wires. Embodiments of the assembly can include a vehicle side sub-assembly and a trailer-side subassembly.

Embodiments of the assembly can utilize a combination of features to connect and secure wiring that provide a simpler and intuitive installation process. Embodiments can include a center knob which holds a splay of wires on to a cone shaped dowel that can be screwed in and secured in a center position. The assembly can include levers and springs to attach and secure wires. Wires can be inserted while a lever is in an open position and once in place the lever can be lowered to engage a spring that connects and secures the wire.

Additional attachment methods can be utilized to secure components and subassemblies of the device without the use of small screws that can be difficult to install and that can easily be dropped or lost.

### BRIEF DESCRIPTION OF THE DRAWINGS

Operation of the invention may be better understood by reference to the detailed description taken in connection with the following illustrations, wherein:

FIG. 1 is a perspective view of an exemplary embodiment of the wiring connector assembly.

FIG. 2 is a perspective view of another embodiment of the wiring connector assembly.

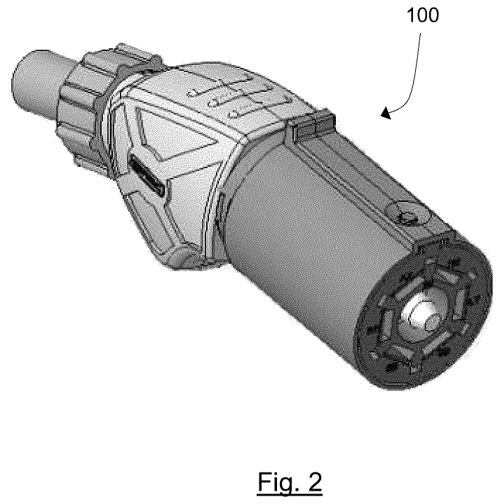

FIGS. 3A & 3B show a wiring connector assembly with an attached vehicle-side connector.

FIG. 4 shows a side perspective cross-section of a trailer side sub-assembly of the wiring connector assembly.

FIG. 5 shows an exploded perspective view of a trailer side sub-assembly of the wiring connector assembly.

FIGS. 6A & 6B show a cross-section of a center wire prior and after installation respectively into trailer side sub-assembly.

FIGS. 7A & 7B show a perspective view of a wire being inserted into a trailer side sub-assembly.

FIG. 8 is a side cross-section view of lower terminal puck and back puck of an assembled trailer side sub-assembly.

FIG. 9 is an exploded side perspective of lower terminal puck and back puck of a trailer side sub-assembly.

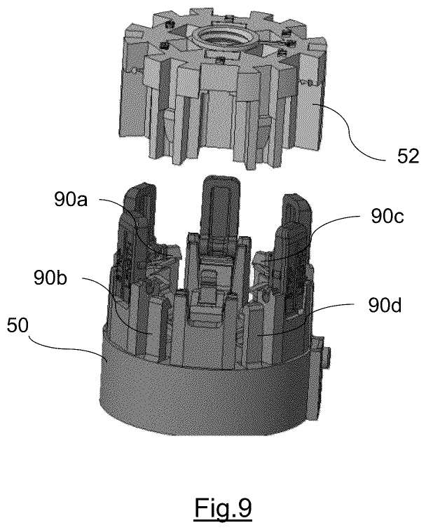

### DETAILED DESCRIPTION OF PREFERRED EMBODIMENTS

The disclosures of this patent application, including the descriptions, drawings, and claims, describe one or more embodiments of the invention in more detail. Many other features, objects, and advantages of the invention will be apparent from these disclosures to one of ordinary skill in the art, especially when considered in light of a more exhaustive understanding of the numerous difficulties and challenges faced by the art. While there are many alternative variations, modifications and substitutions within the scope of the invention, one of ordinary skill in the art should consider the scope of the invention from a review of any claims that may be appended to applications and patents based hereon, including any amendments made to those claims in the course of prosecuting this and related applications.

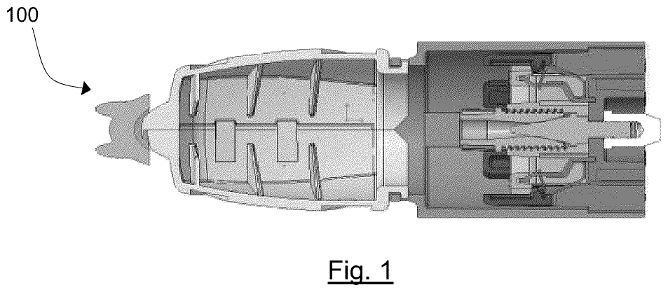

FIGS. 1 & 2 show embodiments of the wiring connector assembly 100. Embodiments of the wiring connector assembly 100 connect and secure wiring to transfer power to a towed vehicle from a towing vehicle for lighting, auxiliary power, and brake systems. Assemblies 100 can provide for wire retention for 18 thru 10-gauge wires.

Embodiments of the assembly 100 can utilize a combination of features to connect and secure wiring that provide a simpler and intuitive installation process. Installing the assembly 100 does not require a screwdriver or small screws which can be too small for a user to comfortably use, but rather spring retention of the wires without the use of tools. The wiring connector assembly can be adapted to use standard wires and plugs conventionally used for towing vehicles. Those skilled in the art will recognize that the non-limiting embodiments provided in FIGS. 1 & 2 are only for illustrative purposes and many other designs can be utilized that achieve the same results.

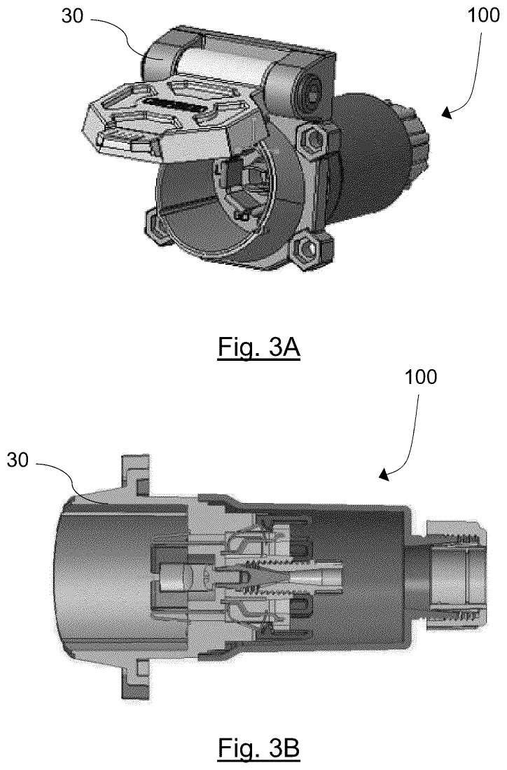

FIGS. 3A & 3B show the wiring connector assembly 100 with an attached vehicle-side connector 30. Attached vehicle-side connector 30 is configured to attach or mount to a towing vehicle and a cover may be included to protect the opening when not attached to vehicle.

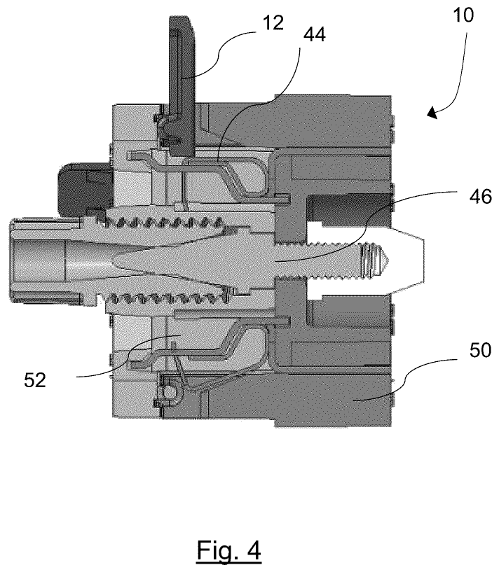

FIG. 4 shows an embodiment of the trailer side sub-assembly 10 of the wiring connector assembly 100. The trailer side sub-assembly 10 can include levers 12, springs 44, a cone shape dowel 46, lower terminal puck 50, and back puck 52. In some embodiments there can be six levers 12 and springs 44 spaced at 60 degrees around the center of the sub-assembly 10, however, other configurations of the levers 12 and springs 44 can be utilized. The springs 44 can be oriented to apply outward force against to hold a wire in place once the lever 12 is in a closed position. The components of the trailer side sub-assembly 10 snap together and are secured without the use of screws.

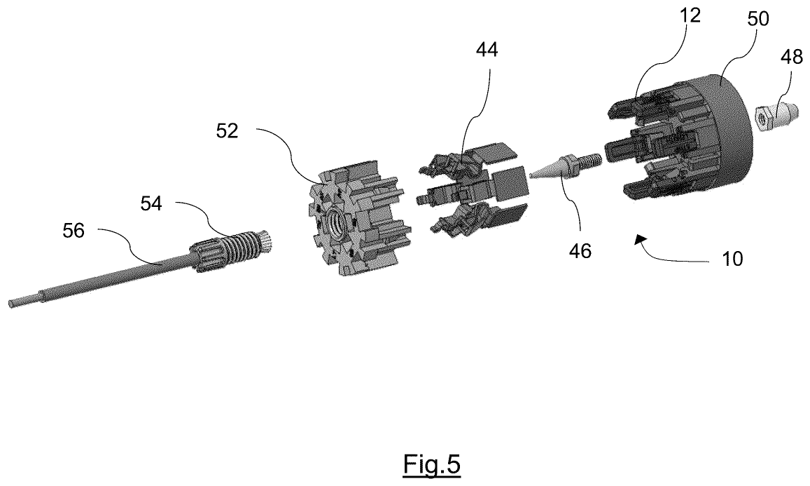

FIG. 5 shows an exploded view of a trailer side sub-assembly 10. A cap 48 secures the cone shape dowel 46 to the trailer side sub-assembly 10. Also seen is a center knob 54 which holds a splay of wires 56 which is inserted into the trailer side sub-assembly 10.

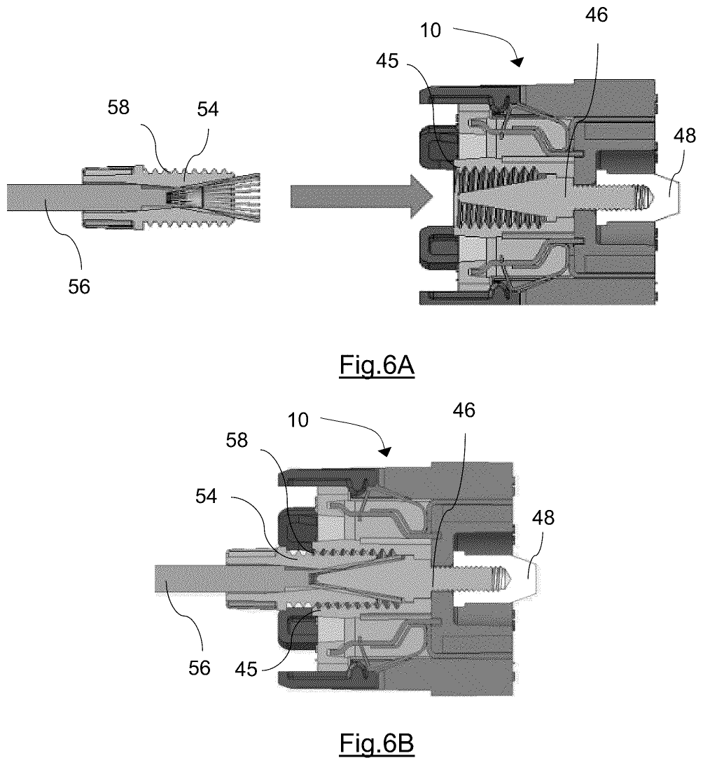

FIGS. 6A & 6B illustrate the center knob 54 being inserted into the trailer side sub-assembly 10. As the center knob is inserted 54, the threads of the center knob 58 meet the matching threads 45 of the trailer side sub-assembly 10. The splay of wires surrounds the cone shape dowel 46 which is secured with a cap 48. The splay of wires 56 is connected and secured within the trailer side sub-assembly 10 as the center knob 58 is interlocked.

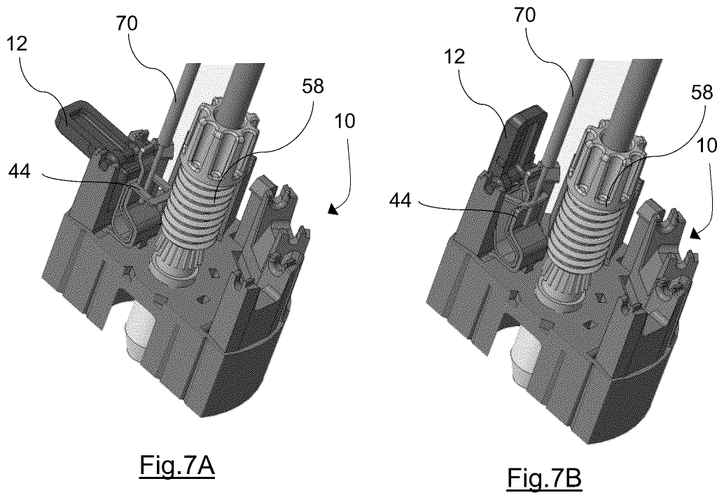

FIGS. 7A & 7B which illustrate a wire 70 being inserted into the trailer side sub-assembly 10. After the center knob 58 has been attached to the trailer side sub-assembly 10, additional wires 70 are connected to the trailer side sub-assembly 10. FIG. 7A shows a lever 12 in an open position, in this example, the lever 12 is flipped vertically. Once the wire 70 is inserted the lever 12 can be flipped to a closed position. The closed position, as seen in FIG. 7B as a horizontal position. Once the lever 12 is in a closed position, the lever 12 engages a spring 44 to connect and secure the wire 70 to the trailer side sub-assembly 10. The spring 44 can be made of a conductive material and be shaped to allow an opening for the wire 70 which closes when the lever 12 is in a closed position.

Those skilled in the art will recognize that the non-limiting examples provided are for illustrative purposes and many methods of wire attachment can be utilized to achieve the same effect. Various methods of connecting the center wire or additional wires to the trailer side sub-assembly 10 can be used in embodiments of the wiring connector assembly 100.

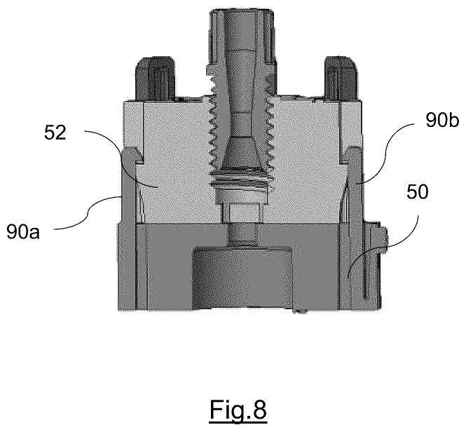

FIGS. 8 & 9 show a side perspective cross-section after assembly, and an exploded side perspective before assembly of the trailer side sub-assembly 10 respectively. In these examples, the lower terminal puck 50, and back puck 52 of the trailer side sub-assembly 10 are connected and secured with latches 90a, 90b. The components of the trailer side sub-assembly 10 can be assembled without the use of screws or additional tools, in this non-limiting example, latches 90a-90d are utilized, but other forms of attachment can be used.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A wiring connector assembly to connect a towing vehicle to a towed vehicle, comprising:
a central connection configured to receive a central wire;
at least one lever; and
at least one spring;
wherein the lever is movable between an open position wherein the at least one spring receives at least one perimeter wire therein, and a closed position wherein the at least one wherein the at least one spring secures the at least one perimeter wire to the wiring connector assembly.

2. The wiring connector assembly of claim 1, wherein the central connection has a set of threads configured to threadbly receive the central wire within a central wire holder.

3. The wiring connector assembly of claim 1, wherein the central connection comprises a cone shaped dowel.

4. The wiring connector assembly of claim 1, wherein wiring connector assembly further comprises a plurality of sub-assembles that are snap fit together.

5. The wiring connector assembly of claim 4, wherein the plurality of sub-assemblies are held in place with one or more latches.

6. The wiring connector assembly of claim 1, wherein the at least one spring is configured to provide outward force to retain the at least one perimeter wire once the lever is in the closed position.

7. The wiring connector assembly of claim 1, wherein the at least one lever and the at least one spring are located on an exterior edge surrounding the central connection.

8. A wiring connector assembly to connect a towing vehicle to a towed vehicle, comprising:
a central connection configured to threadbly receive a wire holder with one or more wires;
at least one lever; and
at least one spring;
wherein the lever is movable between an open position wherein the at least one spring receives at least one perimeter wire therein, and a closed position wherein the at least one wherein the at least one spring secures the at least one perimeter wire to the wiring connector assembly.

9. The wiring connector assembly of claim 8, wherein the central connection comprises a cone shaped dowel.

10. The wiring connector assembly of claim 8, wherein the wiring connector assembly further comprises a plurality of sub-assembles that are snap fit together.

11. The wiring connector assembly of claim 10, wherein the plurality of sub-assemblies are held in place with one or more latches.

12. The wiring connector assembly of claim 8, wherein the at least one spring is configured to provide outward force to retain the at least one perimeter wire once the lever is in the closed position.

13. The wiring connector assembly of claim 8, wherein the at least one lever and the at least one spring are located on an exterior edge surrounding the central connection.

14. A method for connecting wiring from a towing vehicle to a towed vehicle using a wiring connector assembly, comprising the steps of:
assembling a wiring connector assembly, wherein the wiring connector assembly comprises:
a central connection;
at least one lever; and
at least one spring;
inserting a central wire holder into the central connection;
positioning the one or more lever into an open position to allow the one or more spring to receive a one or more perimeter wire;
inserting the one or more perimeter wire into an opening in the one or more spring; and
positioning the one or more lever into a closed position that manipulates the one or more spring to secure the wire in place.

15. The method of claim 14, wherein the central connection has a set of threads configured to threadbly receive the central wire within a central wire holder.

16. The method of claim 14, wherein the central connection comprises a cone shaped dowel.

17. The method of claim 14, wherein wiring connector assembly further comprises a plurality of sub-assembles that are snap fit together.

18. The method of claim 17, wherein the plurality of sub-assemblies are held in place with one or more latches.

19. The method of claim 14, wherein the at least one spring is configured to provide outward force to retain the at least one perimeter wire once the lever is in the closed position.

20. The method of claim 14, wherein the at least one lever and the at least one spring are located on an exterior edge surrounding the central connection.

21. The method of claim 14 wherein assembling the wiring connector assembly is performed without additional fasteners.
